(19) United States
(12) Patent Application Publication
(10) Pub. No.: US 2013/0259014 A1
(43) Pub. Date: Oct. 3, 2013

(54) Location Based Data Delivery Schedulers

(71) Applicants: Philip Orlik, Cambridge, MA (US); Ke Xu, Clemson, SC (US)

(72) Inventors: Philip Orlik, Cambridge, MA (US); Ke Xu, Clemson, SC (US)

(21) Appl. No.: 13/436,047

(22) Filed: Mar. 30, 2012

(51) Int. Cl. H04W 72/12

(52) U.S. Cl. 370/337

(57) ABSTRACT

Packets are transmitted by a server to mobile nodes in a coverage area of a wireless network using a coverage and reliability map, which indicates qualities and reliabilities of links between the server and the nodes. When a new packet is received in the server, the server transmits the packet if a current load of the packets including the new packet is less than a peak load constraint. Otherwise, the new packet is delayed for one time slot.

### FIELD OF THE INVENTION

This invention relates to wireless communications, and more particularly to mobile communications and application layer scheduling of packets for mobile devices.

### BACKGROUND OF THE INVENTION

Vehicular networking has drawn significant attention recently as automotive and communication industries have plans to bring ubiquitous broadband Internet connectivity to mobile devices in vehicles. Envisioned applications include road safety, driver assistance, information, entertainment, and vehicle telematics. Telematics typically is any integrated use of telecommunications and informatics, also known as ICT (Information and Communications Technology).

The applications use a range of wireless communication methods based on Wi-Fi, dedicated short range radios (DSRC), or 3G/4G radios such as Mobile WiMAX, and long term evolution (LTE). Infrastructure-based vehicular networks, also refers to vehicle-to-infrastructure (V2I) networks, or vehicle-to-roadside (V2R) networks.

These networks use statically deployed access points (APs) or base station (BSs) to connect to mobile devices in vehicles (nodes). Despite the higher costs to deploy and maintain the AP/BS infrastructure, industries and transportation authorities are paying high attention to infrastructure-based networks due to their higher reliability and constant availability where such infrastructure exists.

Scheduling methods for data delivery in mobile wireless networks are known. One method uses link-layer scheduling for non-real-time, non-safety data transmission in V2I systems proposed for the IEEE 802.11e standard. That method attempts to deliver as much information per flow as possible considering both limited radio coverage of road segment and high vehicle speeds.

Another method describes scheduling for the downlink of a cellular network, consisting of joint Knopp and Humblet (K&H)/round robin (RR) scheduler, and resource constrained (RC) scheduling, to achieve capacity gain and minimize channel usage while quality of service (QoS) constraints.

Another method describes physical-layer scheduling and resource allocation mechanism for the downlink in a code division multiple access (CDMA) systems, maximizing a weighted sum throughput.

Another method describes a scheduling mechanism for the downlink of a cellular orthogonal frequency-division multiplexing (OFDM) system, with considerations including integer carrier allocations, different sub-channelization methods, and self-noises due to imperfect channel estimates or phase noise.

Most of the prior art scheduling methods have not sufficiently considered the characteristics of applications in vehicular networks, and also depend on a specific low-layer technologies of radio access network (RAN). Only a few prior art works are focused on the scheduling for the applications in vehicular networks.

One method describes application-layer service scheduling of vehicle-roadside data access, considering service deadline, data size, and broadcasting.

### SUMMARY OF THE INVENTION

The embodiments of the invention are focused on scheduling methods for telematics service in vehicular networks. Specifically, the schedulers are implemented in a server for navigation system, such as iPhone, Google Navi, and Android Navi, to achieve high efficient data delivery for mobile devices, regardless of a specific RAN.

An objective of the schedulers is to minimize resources (bandwidth) on the wireless channels, resulting in reducing the cost for application providers, while satisfying the requirements for mobile users at the same time.

### BRIEF DESCRIPTION OF THE DRAWINGS

FIG. 1A is a schematic of the location base data (LBS) delivery according to embodiments of the invention;

FIG. 1B is a diagram of a Markov chain with four link states according to embodiments of the invention;

FIG. 2 is a block diagram of the scheduler FCFS with peak constraint according to embodiments of the invention;

FIG. 3 is a block diagram of the scheduler FCFS with link reliability according to embodiments of the invention;

FIG. 4 is a block diagram of the scheduler FCFS with peak constraint and link reliability according to embodiments of the invention; and

FIG. 5 is a block diagram of the scheduler FCFS with peak constraint and partial link reliability according to embodiments of the invention;

### DETAILED DESCRIPTION OF THE PREFERRED EMBODIMENT

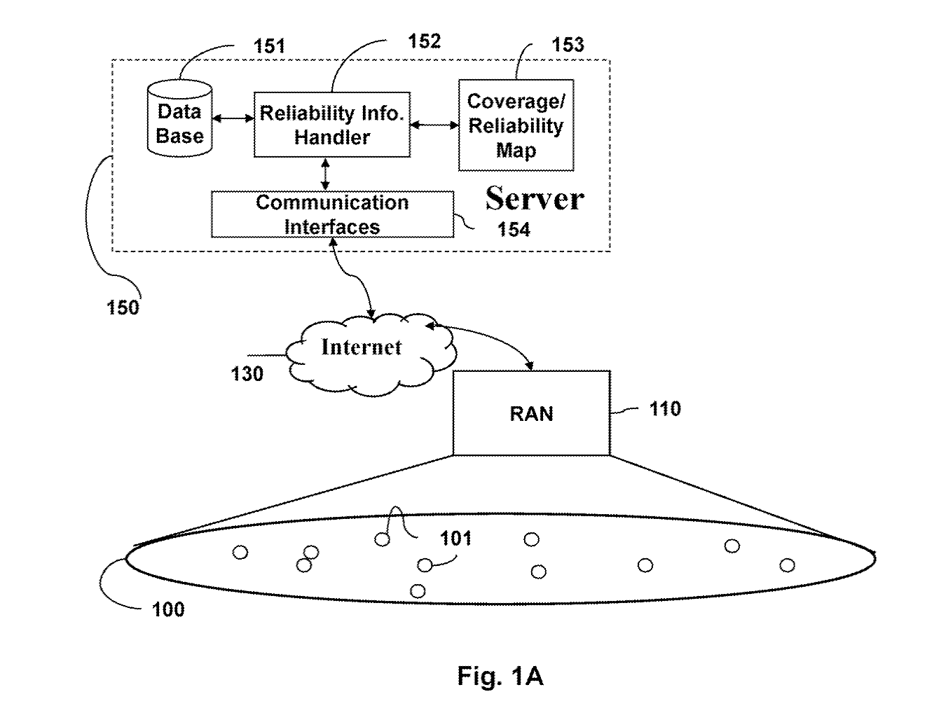

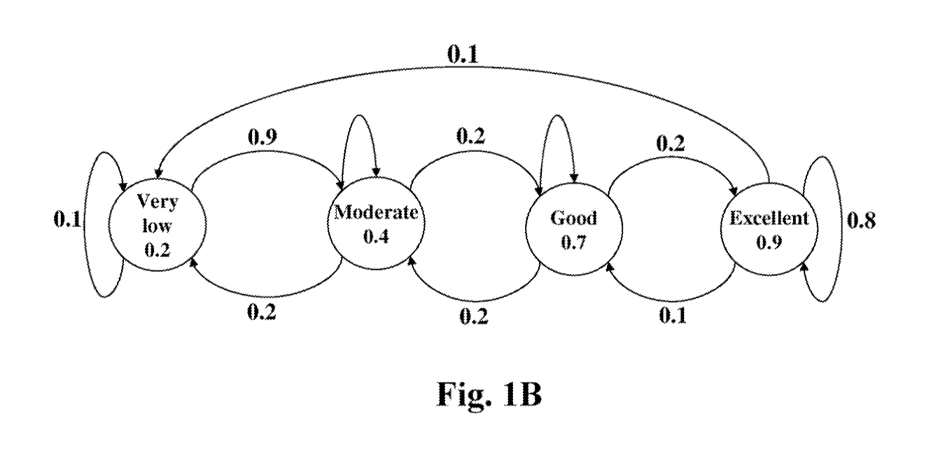

FIG. 1A shows a location base data (LBS) delivery according to embodiments of the invention. A server 150 delivers data to mobiles devices (nodes) 101. The mobile devices are located in a coverage area 100 of a radio access network (RAN) 110. A link capacity is dependents on an access network technology, e.g., LTE, WiMAX, WiFi, etc.

A coverage and reliability map (MAP) 153 is assumed to be known perfectly. The server determines a delivery time for each mobile device and the packets are delivered via the Internet 130 and the RAN, 110, to each mobile device based on information stored in a database 153, to achieve efficient location based services (LBS) for data delivery.

In this case, main application functions are carried out on a telematics server 150. Telematics integrates telecommunications and informatics. The server collects information from vehicles within the coverage area 100, including current position, desired destination, recent drive times and road conditions.

In addition, the telematics server provides information to vehicles in the form of navigation updates and location based services, such as points of interest messages. The telematics server includes a database 151, a reliability information handler 152, a coverage map 153, and various communication interfaces 154. The database contains information pertaining to points of interest and the location of client vehicles 101.

Hereinafter, mobile devices (mobiles) and vehicles, collectively “nodes,” are used interchangeably because the vehicle can have an integrated on-board mobile device, or the mobiles can be carried by any of the vehicle occupants.

The reliability information handler 152 manages the tasks of transmitting route update information and other messages to the vehicles, as well as receiving position updates, telematic data, and service requests from the vehicles. A key feature of the telematics server is the use of the coverage map 153, which provides a map of link quality for the area covered by the RAN. The reliability information handler uses the MAP data to perform tasks, such as scheduling packet transmission to the vehicles based on their position and the corresponding link quality stored in the coverage map at that position. The details of several scheduling methods are described below.

The steps of the methods are performed in a processor at the server, including memory and input/output interfaces as described above, and known in the art.

Our invention provides four embodiments of location base data delivery scheduler considering peak traffic constraint and link reliability for the data server in infrastructure-to-vehicle networks.

These four embodiments of the scheduler methods are:

(1) First come first serve (FCFS) with peak constraint;

(2) FCFS with link reliability;

(3) FCFS with peak constraint and link reliability; and

(4) FCFS with peak constraint and partial link reliability.

In general, it is desirable that the scheduler in the telematics server, 150, attempts to minimize the total traffic that is sent over the RAN, 110. As noted above, the scheduler has access to the coverage map and also has knowledge of each mobile's location in the service area, or has an estimate of the mobile location from previous driving histories, location updates or navigation routes the mobile is following.

Thus, one approach to minimize the total traffic is to wait until the mobile is in a location in which the coverage map indicates there is a high probability of reception. Then, the scheduler transmits any packets destined to the vehicle. This approach, however, does not take into account the delay incurred by waiting for favorable channel conditions. One can also consider that information destined for each vehicle needs to be delivered in a timely fashion and simply waiting for a favorable channel causes too much scheduling delay.

To achieve this goal of minimizing traffic and delay, we consider constraining the scheduling of packets according to two metrics. The first metric is the total offered load. The second metric is the average excess delay. The total offered load is the total number of transmissions including the initial transmissions and retransmissions. The average excess delay is the time a packet waits if it is not scheduled for transmission at the instant at which it arrives at the telematics server.

The scheduler operates in a slotted fashion. That is, during each time slot, the scheduler examines pending packets and decides whether to transmit the packet in the current time slot, or delay transmission to a subsequent slot.

The time required to transmit the packet is short compared with a scheduling slot so that packet transmission time along with all necessary retransmissions occurs within a duration of a time slot.

FIG. 1B shows states and transitions between states of the mobile device as represented as a Markov chain. The reliability map is quantized into four states, which are very low, moderate, good and excellent, with probability of successful transmission being 0.2, 0.4, 0.7 and 0.9, respectively. We note that FIG. 1B is an example of a particular model of the time varying evolution of the channel experienced by each mobile as the mobile traverses the coverage area. Our intent is to show how the various scheduling methods perform with time varying channels and link qualities. For our methods, the particular model used to generate realizations of link qualities is a secondary concern. The major assumption that needs to be fulfilled in order to implement our methods is the existence of a coverage map at the server that enables the telematics server to predict the link quality for each of the mobiles at a particular location. This coverage map is accessible at the telematics server.

According to the Markov chain in FIG. 1B, a stationary distribution of link states {very low, moderate, good, excellent} is {0.1 127, 0.3803, 0.2535, 0.2535}. We use one minute for the time slot, and an average excess delay means the average amount of time a packet waits for transmission, in terms of the time slot ignoring the packet length.

FCFS with Peak Constraint

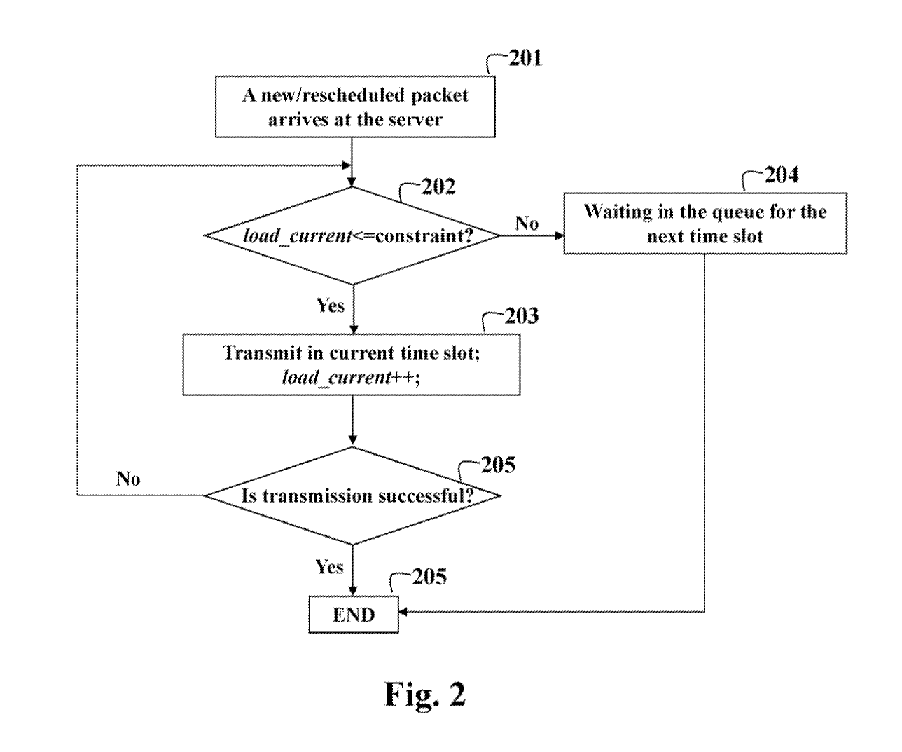

FIG. 2 shows the first embodiment of the scheduler FCFS with peak constraint. The scheduler sets a peak constraint and only transmits and retransmits the packet when the offered load in the current time slot has not exceeded the peak constraint.

A new or rescheduled packet arrives 201 at the server. The server makes a decision 202 by checking the offered load in current time slot, load current,. against. a peak constraint.

If the value of load_current is less then the peak constraint, then this packet is scheduled to be transmitted 203 in the current time slot, and load current increases by one.

If no, the packet is delayed by storing the packet in a queue 204, and waiting until a next scheduling time slot. After transmitting in current time slot, the server checks 205 the success of transmission for this packet.

If this transmission is successful, the procedure goes to END 206, and if not successful, the procedure goes to step 202 to make a decision for retransmitting or rescheduling.

The scheduling procedure described in FIG. 2 only considers the peak constraint, and does not make use of the coverage map in determining the scheduling slot. Thus, a packet destined for a mobile device that is currently in a region with poor coverage can be retransmitted many times within the scheduling slot. This causes the packets destined to. other devices to be unnecessarily delayed. That is, if the scheduler had selected to only deliver packets to devices in a good to excellent coverage area, then more packets could have been delivered. This case is considered next.

FCFS with Link Reliability

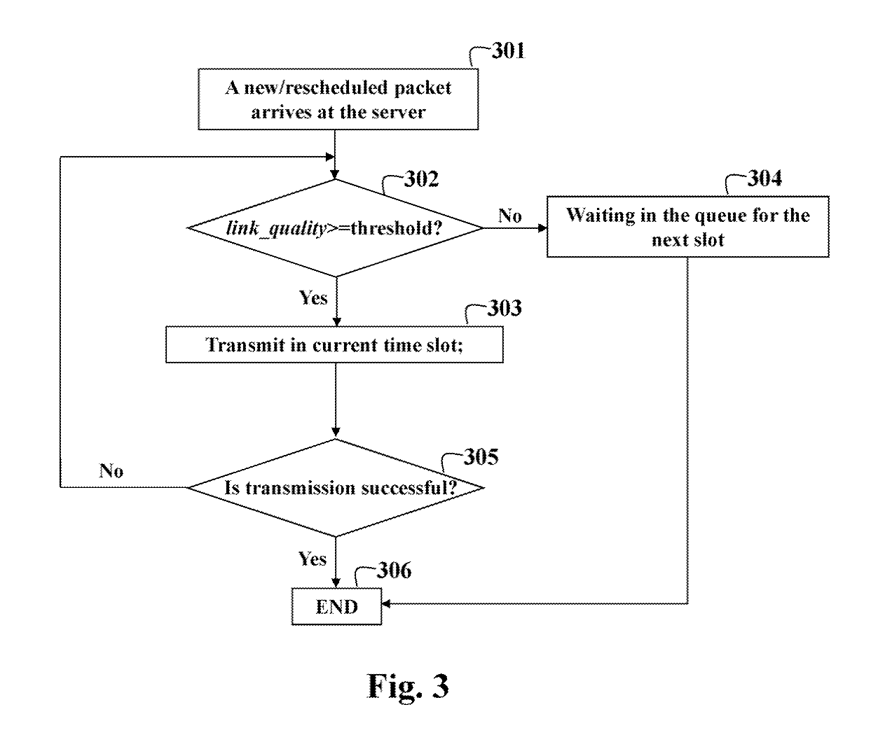

FIG. 3 shows the second scheduler FCFS with link reliability. This scheduler is designed to schedule the packets during the times of high link quality to reduce the retransmissions, resulting in reducing the total offered load.

A new or rescheduled packet arrives at the server 301.

The server makes a decision by first checking 302 the link quality to the destination device in current time slot to insure that the value, link_quality, is above a given threshold of link reliability.

If yes, this packet is scheduled to be transmitted 303 in current slot.

If no, the pack waits 304 in the queue for the next slot. After transmitting in current slot, the server checks 305 the success of transmission for this packet. If this transmission is successful, the procedure goes to END 306, and if not successful, the procedure goes to step 302 to make a decision for retransmitting or rescheduling.

This process ensures that only mobile devices in areas where the link quality is above the scheduler's threshold are served. However, it does not guarantee any peak traffic constraint because the scheduler transmits all of the packets for which the devices have reasonably good link quality. We can combine the features of the two methods above to consider both peak traffic constraint and link quality.

FCFS with Peak Constraint and Link Reliability

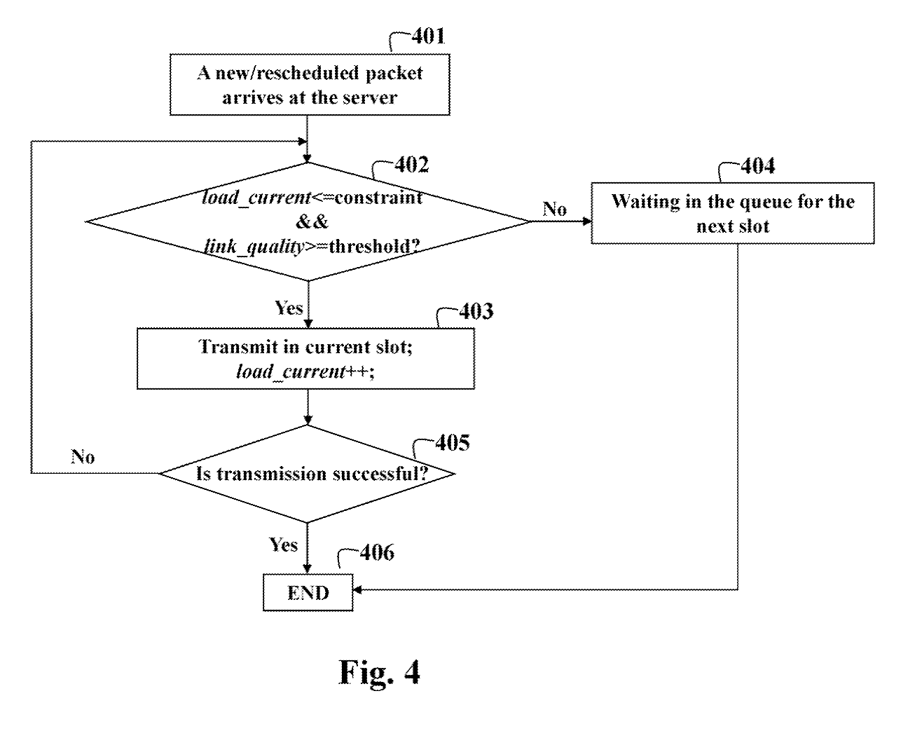

FIG. 4 shows the third scheduler FCFS with both peak constraint, and link reliability. This scheduler avoids exceeding a peak constraint and also uses the reliability map to schedule the transmissions during times of high link quality.

A new or rescheduled packet arrives 401 at the server. The server makes a decision by comparing 402 the offered load in current slot load current with peak constraint and comparing the link quality in current slot link_quality with the reliability threshold 402.

If yes, the packet is scheduled to be transmitted 404 in current slot and load_current increases by one.

If no, the packet is delayed 404 until the next scheduling slot.

After transmitting in current slot, the server checks 405 the success of transmission for this packet. If this transmission is successful, the procedure goes to END 406, and if the transmission fails, the procedure goes to step 402 to make a decision for retransmitting or rescheduling.

Thus, only packets that are destined for mobiles in regions of high link quality are transmitted, as long as the total number of transmission attempts has not exceeded the peak constraint. This scheduling method reduces the offered load in the RAN because the number of retransmission is limited by the link quality threshold. In addition, the scheduler imposes a limit on the total number of transmission attempts by enforcing the peak constraint.

Due to the persistent checking of link quality at the scheduler, the delay incurred by some packets can be significant, because some mobiles can be in regions of poor coverage. These mobiles do not have any packets scheduled for delivery until they move into better coverage areas.

Thus, we can allow some relaxation of the link quality constraints to attempt the delivery of packets even when the link quality is known to be below the threshold. This has the effect of reducing the excess delay incurred by the scheduler at the expense of some increase in the offered load.

FCFS with Peak Constraint and Partial Link Reliability

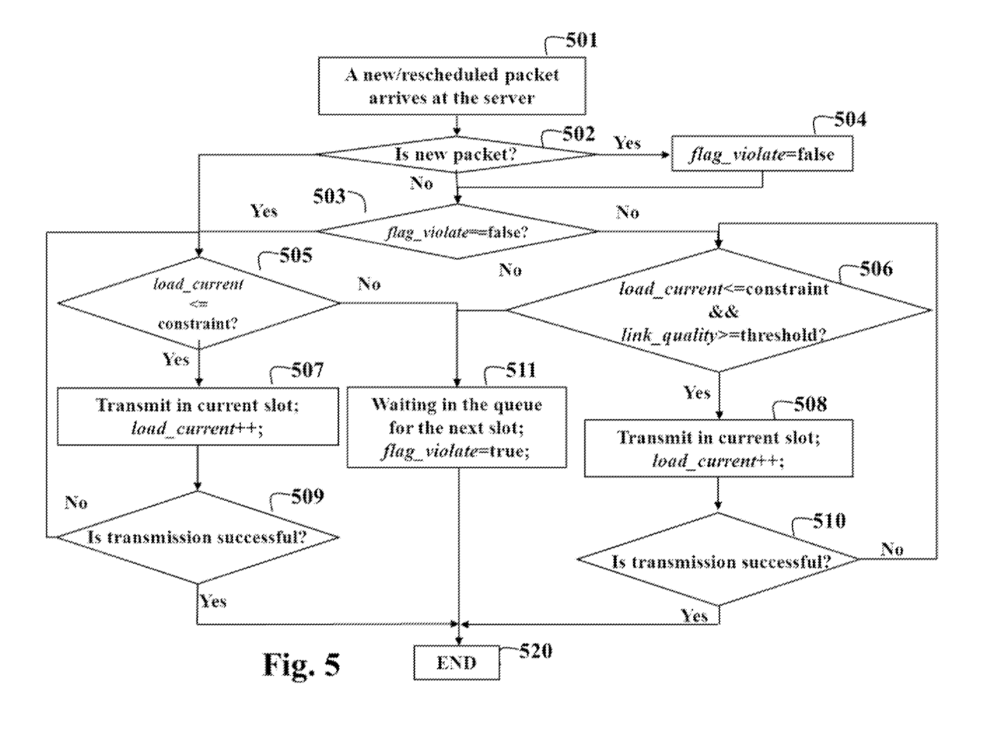

FIG. 5 shows the fourth scheduler FCFS with peak constraint and partial link reliability. This scheduler considers peak constraint for scheduling all the packets, and considers both peak constraint and reliability threshold only for those packets, which violate the peak constraint, in the following transmissions until success.

A new/rescheduled packet arrives 501 at the server.

The server first checks 502 whether this packet is a newly arrived packet or a rescheduled packet. If it is a rescheduled packet the procedure directly goes to make a decision 503 by checking the value of the flag for violating the peak constraint for this particular packet flag_violate.

If this packet is a newly arrived packet the server sets 504 flag_violate as false, and then to step 503.

If the decision for step 503 is yes, then the server makes a decision by only checking 505 the offered load in current. slot load_current with peak constrain.

If the decision in step 503 is no, then the server makes a decision by checking 506 both load_current with peak constraint and link quality in current slot link_quality with the reliability threshold.

After making a decision in steps 505 and 506, the following procedures are similar, and as described above.

If the decision is yes, then the packet is scheduled to be transmitted 507 or 508 in current slot and load current increases by one.

If no, the packet is delayed 511 for the next slot, and the server sets flag_violate as true.

After transmitting in current slot, the server checks 509 or 510 the success of transmission for this packet. If this transmission is successful, the procedure goes to END 520, and if not successful, the procedure goes back to respective steps 505 or 506 to make a decision for retransmitting or rescheduling.

In the following paragraphs, the four scheduler are referenced as (1), (2), (3), and (4) for simplicity.

The total offered loads of all four schedulers are near to that of FCFS with no scheduling when reliability threshold is 0.2 (state “very low”).

The reliability threshold (>0.2) has apparent. effects on reducing the total offered load taking advantage of transmitting if seeing high link quality. Scheduler (2) and Scheduler (3) are the best two schedulers when reliability threshold is 0.4, 0.7, and 0.9, while Scheduler (4) is medium, and Scheduler (1) is the worst, e.g. the best two are better than the latter two by 80% and 100%, approximately, when the packet arrival rate is 0.006 and reliability threshold is 0.7.

The average excess delay of Schedulers (1), (3) and (4) is near to each other when reliability threshold is 0.2 (state “very low”), while that of Scheduler (2) is the lowest due to the low reliability threshold has negligible effects on the delay compared to that caused by peak constraint.

When the reliability threshold is 0.4, it is indicated that the delay of Schedulers (1) and (4) is lower than the other two if the traffic load is small, e.g. the packet arrival rate is below 0.003 packets/min. The performance of the scheduler (2) is stable and flat as the packet arrival rate increases.

The delay by Schedulers (1), (4), and (3) is significantly increased as the traffic load is large, e.g. exceed the delay by the Scheduler (2) by 859.78%, 589.58%, and 285.1%, respectively, when packet arrival rate is 0.006.

The performance of delay is similar for reliability threshold is 0.7 and 0.9, which indicates that the delay is not affected by the increase of threshold after the packets are only allowed during relatively “good” link quality or higher.

### Effect of the Invention

There exist tradeoffs between achieving small total offered load and small average excess delay. The choice for type of scheduler and reliability threshold at the server depends on the tolerance for offered load and excess delay by specific applications. These choices can be made dynamically during the operation of the network, depending on the factors described herein.

The embodiments of the invention prove the schedulers to minimize resources (bandwidth) on the wireless channels, resulting in reducing the cost for application providers, while satisfying the requirements for mobile users at the same time.

Four embodiments can dynamically be selected depending on various factors during operation of the network, such as link quality, load, reliability and the like.

These four embodiments include first come first serve (FCFS) with peak constraint, FCFS with link reliability, FCFS with peak constraint and link reliability, and FCFS with peak constraint and partial link reliability.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A method for scheduling packets in a wireless network of nodes by a server in a coverage area, wherein each node includes a mobile device capable of communicating with the server, comprising the steps of:
receiving a new packet in the server for a destination node;
determining whether a current load of the packets, including the new packet, to be transmitted in a current time slot is less than a peak load constraint;
transmitting the new pack in the current time slot. to the destination node if true, and otherwise;
delaying the new packet for one time slot, wherein the steps are performed by a processor at the server.

2. The method of claim 1, wherein each node is associated with a vehicle.

3. The method of claim 1, further comprising:
determining, using a coverage and reliability map, whether a quality of a link from the server to the destination node is above a predetermined threshold;
transmitting the packet in the current slot, if true, and otherwise delaying the new packet for the one time slot.

4. The method of claim 1, wherein the packets include telematic data.

5. The method of claim 1, wherein a link capacity is dependents on an access network technology of the network.

6. The method of claim 1, wherein the current load is incremented by one if the new packet is transmitted.

7. The method of claim 1, wherein the scheduling minimizes traffic and delay of the packets in the coverage area.

8. The method of claim 1, wherein the new packet is a previous new packet that was delayed and is to be rescheduled.

9. The method of claim 1, wherein the current load is incremented by one if the new packet is transmitted.

10. The method of claim 1, wherein the server has access to a coverage and reliability map (MAP).

11. The method of claim 1, further comprising:
collecting, in the server, current positions, desired destination, recent drive times and road conditions for the nodes in the coverage area.

12. The method of claim 4, wherein the telematic data includes navigation updates, and location based services.

13. The method of claim 1, wherein constraints on the scheduling include total offered load, and an average excess delay.

14. The method of claim 13, wherein the total offered load is a total number of transmissions including initial transmissions and retransmissions of the packets, and the average excess delay is a time packets are delayed.

15. The method of claim 1, wherein the scheduling is dynamic during an operation of the network.

16. The method of claim 1, wherein the new packet is transmitted independent of a quality of a link to the destination node.
